(19) United States
(12) Patent Application Publication
(10) Pub. No.: US 2005/0177537 A1
(43) Pub. Date: Aug. 11, 2005

(54) System and method for integrating existing computer-based systems

(76) Inventor: Robert B. Thompson JR., Rancho Cucamonga, CA (US)

Correspondence Address: Michael J Bell;Howrey, Simon, Arnold & White, LLP, Box No. 34, 1299 Pennsylvania Avenue, NW, Washington, DC, 20004-2402, US

(21) Appl. No.: 10/699,356

(22) Filed: Oct. 31, 2003

Related U.S. Application Data
(60) Provisional application No. 60/422,826, filed on Oct. 31, 2002.

(51) Int. Cl. G06F 7/00

(52) U.S. Cl. 707/1

(57) ABSTRACT

The present invention provides system and method of integrating existing computer-based systems. These existing computer-based systems are systems that are in place for a period of time and may be expensive to replace. Specifically, the present invention provides software, firmware and/or hardware for integrating existing computer-based systems. The present invention also allows for the optimization of data sent to computer system before the computer system otherwise utilizes the data. The present invention further allows for selectively bypassing the optimization system of the present invention when the computer system requests data directly from the data source.

### FIELD OF THE INVENTION

The invention is related to systems and methods for integrating existing computer-based systems. These existing computer-based systems are systems that are in place for a period of time and may be expensive to replace. Specifically, the present invention provides software, firmware and/or hardware for integrating existing computer-based systems. The present invention may also allow for the translation of data from a first system format to a second system format, and also provides for the integration of existing computer-based systems to provide for unified data records. The invention can be implemented in hardware, firmware and/or computer software executed on conventional computers.

### BACKGROUND OF THE INVENTION

Existing Computer-Based Systems

There are many systems in use today in various fields of use where quick, efficient, or automated responses may be needed. These systems are necessarily implemented at one particular time and with designs and data formats that apply at the time of implementation. When people attempt to integrate multiple systems at a later time, they are often found to be incompatible.

There are many areas where systems are implemented to perform particular tasks, and later these systems need to be integrated with other systems to perform the same tasks on a larger scale, or to perform a portion of an alternative task. For instance banking, air traffic control, robotics and naval combat systems all need to seamlessly integrate systems with varying designs. Two banks that merge may need to make their systems that monitor and implement transactions compatible so that a user from the first bank may seamlessly withdraw funds from an ATM of the second bank.

Similarly, air traffic control radar stations may need to share information among radars that have different signaling parameters. Also, robotic sensors may need to provide information to other integrated components of a robotic system which were not part of the original design of the system. Additionally, naval combat systems may need to be integrated so that information such as signals, messages and records from the various surface ships, aircraft and other military platforms are able to communicate and interoperate with each other.

Thus, such systems generally need to be altered or enhanced to allow for the integration of two or more legacy systems. However, current systems provide no simple way to alter or enhance systems to allow for their integration without altering the original systems. Altering or upgrading older systems is an expensive and time-consuming option.

A particular integration problem resides with systems of the United States Navy. Each Naval platform may have its own system for tracking and classifying friendly, neutral and enemy positions and movements. Until now, there has been no way to integrate these systems and make them interoperable without substantial and costly alterations to the combat platforms' systems in use. Thus, there is a need for a practical and cost-efficient system for allowing installed computer-based systems to be integrated to work together according to updated requirements, without replacing or substantially altering the older systems.

### SUMMARY OF THE PRESENT INVENTION

The present invention efficiently integrates existing computer-based systems and platforms. In particular, the present invention integrates systems and platforms of armed forces such as surface vessels, aircraft and land forces.

The present invention provides a system and method for integrating existing computer-based systems that are expensive or time consuming to upgrade. It further allows for the interoperability of existing computer-based systems without direct upgrades to the existing computer-based systems.

Advantageously, embodiments such as a computer-readable medium (e.g. a CD-ROM, DVD, or other suitable medium) having computer-executable instructions for performing a method integrating existing computer-based systems are all within the scope of the present invention.

Optimization of data sent to the system before it is used by the system as well as allowing for selective bypassing of the system's optimization features is also a useful feature of the invention.

Included as well is a system for transforming data including a plurality of first interfaces to receive data, a subsystem to transform received data into data recognizable by a second system, and a second interface to send data to a second system.

The present invention also includes a method of generating signals derived from received signals. The method includes the steps of creating optimized signals from a set of received signals, transforming the optimized signals into signals recognizable to a specific system, and providing signals recognizable to a specific system to the specific system.

Further, the present invention includes a system for integrating Naval and Maritime Combat Platforms. This system includes implementing a common network interface on a plurality of naval combat systems. The common network interface's capabilities include receiving signals and messages including track data from sources including sensors, host combat systems, and other systems. The common network interface can also optimize the signals and messages and create a track file that includes the best set (including added improvements) of the signals and messages. The common network interface also emulates the signals and messages a host combat system would expect to receive in order to cause the host combat system to implement the optimization of the signals and messages.

### BRIEF DESCRIPTION OF THE DRAWINGS

The present invention may be better understood with reference to the detailed description in conjunction with the following figures, where like numerals denote identical or similar elements, and in which:

FIG. 1 is a block diagram of a system in which multiple diverse systems are integrated.

FIG. 2 is a block diagram of a system in which multiple diverse systems are integrated with an embodiment of the present invention.

FIG. 3 is a block diagram of a Common Network Interface (CNI) system on a single combat system.

FIG. 4 is a block diagram of a computer-based system without a CNI system.

FIG. 5 is a block diagram of a computer-based system with a CNI system.

FIG. 6 is a block diagram of an alternative embodiment of the configuration of the CNI system.

### DETAILED DESCRIPTION OF THE VARIOUS EMBODIMENTS

This application claims the benefit of U.S. Provisional Application No. 60/422,826, filed Oct. 31, 2002 entitled “Common Network Interface (CNI)”, which is incorporated herein by reference.

Integration of Existing Computer-Based Systems

The integration of existing computer-based systems is important in a world of changing technologies. As each new generation or model of a system is created it must be able to communicate with models of older generations. The communications between the older and newer systems may be viewed as an exchange of messages, signals and records as well as transformations of data between the two systems. This transformation may be made with the aid of hardware, firmware and/or software (collectively referred to herein as “logic”) designed to transform communications and records (in both directions) that are understood and accepted by one platform into communications and records that are understood and accepted by another platform. A program module can be implemented to capture any of the logic described herein.

There are a variety of areas where such a transformation system would be useful, including banking, air traffic control, robotics and military combat systems. With the present invention, changes may be made over time to a group of coordinated systems to save money and allow for a lengthy window for replacement and enhancement.

For instance, in recent years banks and other large industrial and financial organization have seen much consolidation. This consolidation leads to situations where systems of two or more previously disparate organizations need to be consolidated to work as a single system. A single transformation system or layer capable of transforming signals, messages and/or records from one system to another would be able to allow for the integration of these systems. For instance, the transformation system would be able to provide the messages and records that each system would natively recognize to cause a withdrawal or a deposit to be entered and verified.

Similarly air traffic control and robotics could use the benefit of such a transformation system. The transformation system would in each case alter the signals, messages and/or records sent from various systems to the other systems so that they would be understood by each system. The system for which the transformation system alters the signals, messages and/or records is the “target system”.

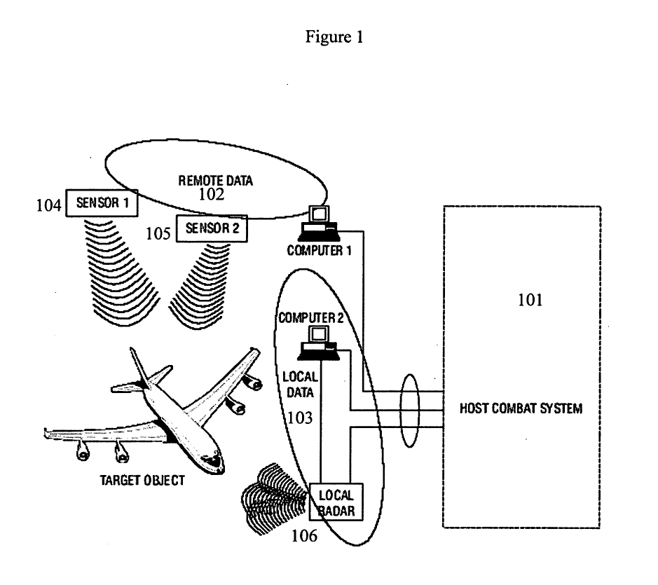

FIG. 1 is a block diagram illustrating integrating diverse systems in the prior art. In this system the host combat system (HCS) 101 processes the remote data 102 and local data 103. The remote data 102 may come from sensors 104 and 105, which are not located on the host combat platform. The local data may be provided by local sensors such as local radar 106. The combining of the local and remote data may lead to problems since the HCS 101 may not be able to properly interpret the remote data 102 in conjunction with the local data 103 for a variety of reasons such as the software on the HCS being unable to interpret some remote data formats. Further, to upgrade the HCS 101 with new hardware, firmware and/or software to function properly may be prohibitively expensive and time-consuming.

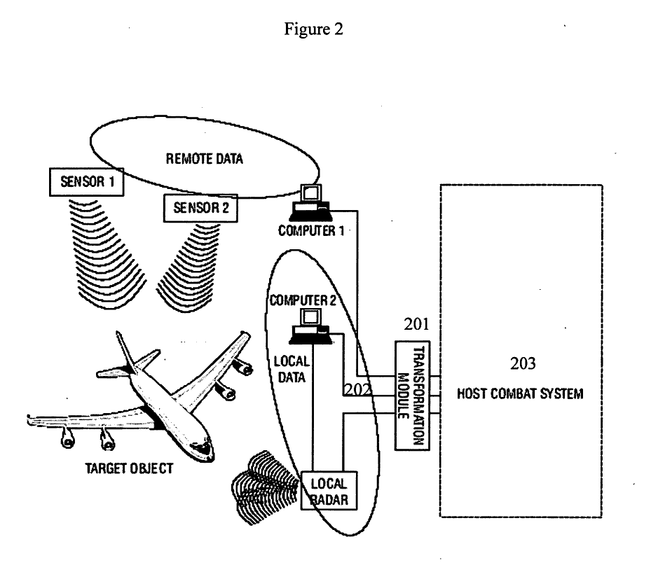

FIG. 2 is a block diagram illustrating integrating diverse systems with a transformation module of the present invention. In this embodiment a transformation module 201 is placed between the incoming data 202 (local and remote data) and the host combat system 203. Being inserted at this location allows the transformation module 201 to preprocess the incoming data 203 and reshape it to a data format useable by the host combat system 203.

Further upgrades need to be performed only on the transformation module 201, which leads to a reduction of time, effort and expense upgrading the system. This is because only a common transformation module needs to be upgraded throughout existing systems rather than the non-identical host combat systems of existing systems.

A preferred embodiment of the present invention may be the common network interface (CNI) developed to integrate naval combat systems. These naval combat systems may include surface ships, submarines, aircraft, satellites and amphibious units.

Integration of an Exemplary System—Naval Combat

Each naval combat platform's system may have its own interface to the outside world. To allow communication among these platforms one may implement a common network interface (CNI) that is able to transform messages and records from any platform into messages and records of any other platform within the ambit of the CNI. The messages and records that CNI focuses on are track files. A track is a conceptual object having a set of attributes such as position, velocity, classification, identification and data valid time.

The CNI may be hardware, firmware and/or software designed to transform information, communications and track files among different platforms' systems. A track is a conceptual object or an abstract record. A track may be data packets with a predefined format, or other structures or signals configured to transmit information about an object. The format or other structures may include a list of information fields. The information fields may include data regarding position, velocity, time, or other characteristics useful to those creating or receiving the track. The CNI may be a layer (e.g. logic of some type) placed between the outside world and the host combat system of the military platform.

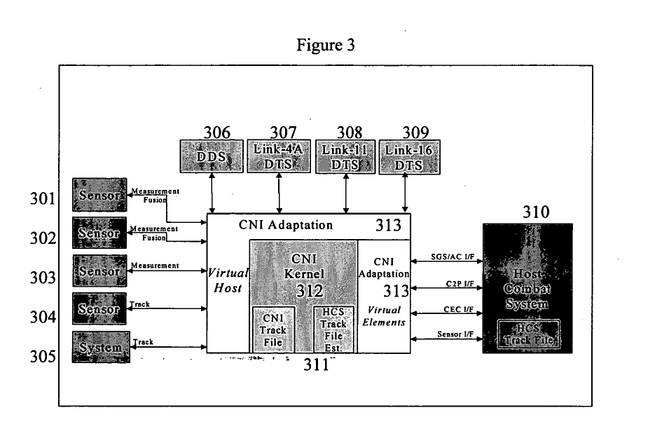

FIG. 3 shows an exemplary CNI instance on a single combat system. The CNI 311 is attached to sensors 301-305, which are attached to the combat system and from which it receives local tracks. The CNI 311 is also connected to networks 306-309, from which CNI receives remote tracks. These networks allow a CNI coupled to a single combat system to interact with other combat systems to create a unified and optimized view of all available track data. The CNI is also connected to the host combat system 310 (HCS), which is the system that operates the displays and local information data processing of the HCS combat platform.

The CNI may include several layers, including a CNI adaptive layer 313 and a CNI kernel layer 312. The CNI kernel layer 312 may be a virtual combat system and be able to create standardized track files, while the CNI adaptive layer 313 may transform track files to and from any combat system to the CNI kernel layer's virtual combat system.

CNI Kernel

The CNI kernel layer 312 may be designed to:
(i) build and maintain a CNI system track file including track histories, based on sensor and tactical data link reports that establishes a CNI system track for each object that CNI perceives in the environment;
(ii) build and maintain supporting source track files based on sensor and tactical data link reports;
(iii) combine identification clues/assessments to determine a consistent force track identification and append these track identification assessments to the appropriate track record in the CNI track file;
(iv) append tactically significant track data from the host combat system (engagement status, air control status, force orders, etc.) to appropriate track record in the CNI track file;
(v) be situated between the host combat system and other interfacing systems, receiving (via the CNI adaptation layer) all interface messages from the host combat system and the interfacing systems, processing the data in the CNI kernel, and sending data back out (also via the CNI adaptation layer) to the host combat system and the other interfacing systems;
(vi) provide internally, mutually consistent, implementations of the data records among the CNI equipped units, based on common data record interpretations;
(vii) build and maintain an estimate of the host combat system's system track file using data in messages received from the host combat system and from the other systems interfacing with CNI; and
(viii) compare records in the CNI system track file with records in the estimate of the host combat system's system track file, and extract track data and order changes to be injected on the host combat system's track file to bring it into congruence with the CNI system track file.

The CNI kernel layer may include preprocessor(s) and force track file creators.

The CNI kernel layer may be designed as a logic module (i.e. including hardware, firmware and/or software).

CNI Adaptive Layer Briefly

The CNI adaptive layer 313 may be designed to:
(i) provide host combat system unique CNI interfaces to the external sensor systems, track identification systems, the tactical data links, correlation/gridlock systems, and insulate the host combat system from these systems;
(ii) provide CNI interfaces to the unique host combat systems using the same system interfaces that the host combat systems used to communicate with these systems (visual sensors, sensor fusion systems, tactical data links, correlation/gridlock systems);
(iii) convert normalized CNI kernel messages to the unique interface formats used by the various host combat systems; and
(iv) convert any unique host combat system interface messages to CNI normalized messages used by the CNI kernel. The CNI layer may include a track file injector function. The track file injection function may be accomplished with the use of a track file injector. The CNI adaptive layer may be designed as a module including hardware, firmware and/or software.

Aspects of CNI Kernel and Adaptive Layer

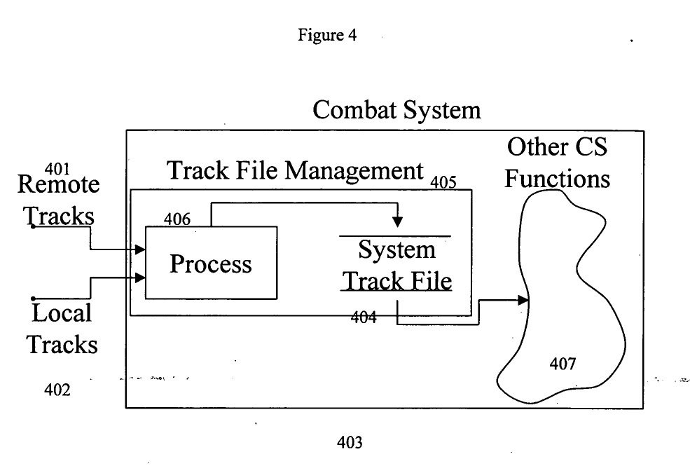

FIG. 4 illustrates a legacy system without a CNI system. The remote tracks 401 and local tracks 402 enter the host combat system 403 directly and are processed by the processor 406 into a system track file 404 by track file manager 405. The command and control function of the combat system then use the generated system track file 404 to generate the outputs needed to operate various command and control features of combat system 403. Other CS functions 407 performs other combat system functions such as operating the radar screens and interfacing with computers that are used by human operators.

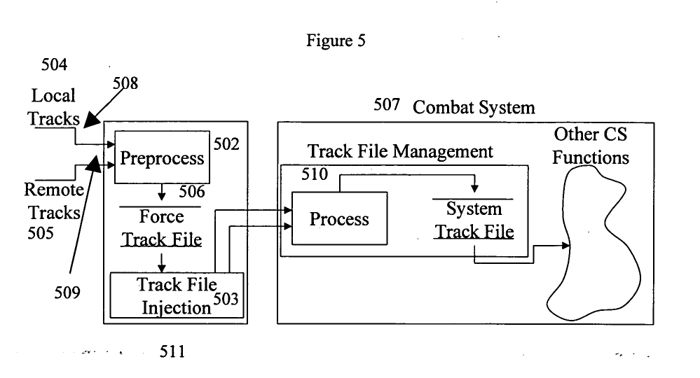

FIG. 5 illustrates a legacy system 507 used in conjunction with a CNI system 501. The CNI system 501 in this embodiment includes a preprocessor 502 and a track file injector 503. The preprocessor 502 receives either or both local tracks 504 and remote tracks 505, and prepares a force track file 506. The force track file includes information generated by the preprocessor describing the tracks that optimally represent the objects of the real world. The force track file 506 is then used by the track file injector 503 to send tracks to the host combat system 507. The host combat system 504 then processes these tracks in a conventional manner.

For instance, the following track files may be provided to the CNI system 501. Over the local channel 508 the CNI system may receive the track (1, 2, 3, 44, 6, 7, Aircraft, Yes, 10:00:01). Over the remote channel 509 the CNI may receive the tracks (1, 2.1, 3, 43.8, 6, 7, Aircraft, Yes, 10:00:02) and (0, 25, 0, 5, 10, 20, Ship, No, 10:00:31). The track file format may be as follows (x-coordinate, y-coordinate, z-coordinate, x-velocity, y-velocity, z-velocity, classification, emitter type, data valid time), with other track file formats possible known to those of ordinary skill in the art.

The preprocessor 502 may determine the validity of the tracks (or selects optimal tracks according to some other predetermined criteria) and mark them accordingly. It may determine the most valid tracks or create additional tracks by any method including standard methods known in the art such as:
(i) coordinated R² control;
(ii) correlation ambiguity reduction
(iii) selected track high update rate;
(iv) high quality multi-source track data;
(v) gridlock information;
(vi) enforce common specification interpretation;
(vii) command and control processor data latency reduction; or
(viii) various registration techniques.

The preprocessor determines the validity of tracks in order to attempt to create the actual picture of reality from the data provided to it. This picture may be the best available picture based on the algorithms used to preprocess the tracks received by the CNI system. This attribute allows commanders in the field to have confidence in both the local and remote tracks the host combat system eventually presents. After the computation to determine the optimal set of tracks, the preprocessor may determine that tracks (1, 2, 3, 44, 6, 7, Aircraft, Yes, 10:00:01) and (0, 25, 0, 5, 10, 20, Ship, No, 10:00:31) represent the best data available.

As the received tracks (1, 2, 3, 44, 6, 7, Aircraft, Yes, 10:00:01) and (1, 2.1, 3, 43.8, 6, 7, Aircraft, Yes, 10:00:02) are similar, the preprocessor may determine that the two tracks represent the same object. The preprocessor then determines which of the tracks (or aggregation of tracks) represents the most probable or optimal track of the object(s). For the example above, the preprocessor determines through the use of algorithms that the track (1, 2, 3, 44, 6, 7, Plane, Yes, 10:00:01) most accurately describes the object. The CNI system will then send emulated tracks corresponding to the recently determined most probable tracks to the host combat system through the track file injector. These emulated tracks cause the host combat system to report the most probable tracks.

Another example of CNI reporting only the most probable or optimal tracks is when a first sensor is reporting a single track and a second sensor is reporting two tracks in the same area. In this case, the preprocessor again determines the most reliable representation of the object(s) to provide to the host combat unit. CNI may determine that the most probable scenario is that there are two objects, and CNI then will provide two tracks to the host combat system. On the other hand, if CNI determines that the most probable scenario is that there is one object, then CNI will provide a single track to the host combat system.

The preprocessor 502 then creates a force track file with all of the tracks it was presented. It may mark the selected optimal tracks as “valid” in the force track file for use by the track file injector.

The track file injector 503 then reviews the force track file created by the preprocessor 502 to determine which track files to provide to the combat system 507. In the example above the track file injector 503 may provide the combat system 507 the track (1, 2, 3, 44, 6, 7, Plane, Yes, 10:00:01) over the local track channel and the (0, 25, 0, 5, 10, 20, Ship, No, 10:00:31) over the remote track channel.

However, some combat systems may not be able to receive data in this format. In those cases, the track file injector will need to transform the data to meet the particular combat systems specifications. For instance, if the track format of the host combat system is (x, y, z, emitter), then the track file injector 503 would provide the combat system the track (1, 2, 3, Yes) over the local track channel and the track (0, 25, 0, No) over the remote track channel. It would remove the extra elements such as “Classification” from the track data before providing the track data to the combat system 507.

Given the above teaching, it is straightforward to transform track data in a first format into track data of a second format, and to generate emulated data to cause the host combat system 507 to display the force track file produced by the CNI module 511.

The CNI module is updatable. As new methods of registration and calculation for determining valid tracks become available, then only the CNI kernel (preprocessor) 502 and not the host combat system process 510 needs to be reprogrammed, replaced or otherwise updated to implement the changes. Similarly, as new host combat platforms and/or systems are developed only the track file injector 503 needs updating, replacement or reprogramming to allow integration of the new platforms and/or systems into the existing force.

When multiple host combat systems employ CNI modules, additional advantages are presented. In this case the CNI unit edits and deletes tracks before they are sent out onto the network. In this way only the best data may be placed on the network, and messages that otherwise may clutter the network are omitted.

Generally, among themselves, the CNI systems will determine which CNI system is the responsible unit for reporting the track for a given object. For instance, if ship A is the responsible unit for a given track, then the CNI unit on ship B may prevent tracks of the corresponding track derived from the local sensors on ship B from being sent across the network to other combat units. This prevention may be accomplished by the CNI on ship B sending a message to the host combat system of ship B to refrain from reporting the status of a particular track to the ship B CNI module.

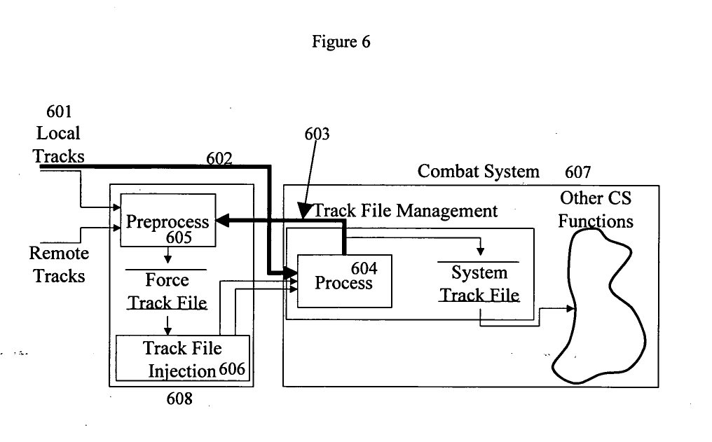

FIG. 6 illustrates a further aspect of the present invention. In some cases it may be beneficial to allow a feedback loop to allow local tracks to directly enter the host combat system and to allow the host combat system to send track data directly to the CNI. Here local tracks 601 are additionally provided a channel 602 to directly be inserted into the process of the combat system 604. Further, tracks may be directly sent from the process 604 to the preprocess 605 of CNI 608.

Such a case is presented when the human operator of a host combat system wishes to override the data assigned to a specific target described by track data. In this case, the operator flags this particular track and uses the host combat system to send a message (track) to the CNI system to adjust its track records accordingly. The operator causes process 604 to send a track over channel 603 to preprocessor 605. This track then contains a flag signaling the CNI preprocessor 605 that a human operator flagged the particular track as a track to accept as accurate. The flagged track causes preprocessor 605 to override the normal algorithms it uses to determine the validity of a track and to simply insert the track into the force track file as one of the tracks representing the optimal representation of the target environment. Then the track file injector 606 will present the combat system 607 with the track as part of the valid picture it provides host combat system 607.

The feedback loop is beneficial to the combat system when it is useful to use the combat system's sensors for fire control. During these missions the local tracks 601 provided over channel 602 directly to combat system 607 are useful. The direct channel 602 which bypasses the CNI system allows the operators viewing the data provided by the host combat system to more accurately provide firing solutions to requesting entities. The systems used in the firing solutions may rely on the combat platform's own sensors and thus have use of this local sensor data. In this case the CNI provides both the data it would normally provide to the HCS as well as the local tracks. If a local track would not normally be provided to the HCS, then the CNI provides it in a way to flag this information to an operator such as by changing a field in the track data to cause the track to appear as a different color. The CNI is able to receive the local tracks directly passing through and being used by the Combat System 607 or the operator by receiving these tracks through channel 603.

Other Fields

Air Traffic Control

Implementing the present invention in an air traffic control system is straightforward. Air traffic is also described with the use of track files. A layer similar to the CNI may be placed on top of each air traffic control system that needs to be updated and able to accept track files similar to CNI track files. By using this process a legacy air traffic control system could be updated to work with newer systems.

Banking Systems

Implementing the present invention to integrate banking systems is also straightforward. As described above each of the existing computer-based systems would receive a module to transform messages and records that appear in earlier formats into common messages and records understandable to the modules. The modules in turn would transform the common messages and records to the proper existing computer-based messages and records. For instance a customer may use an ATM of one existing computer-based system while the customer's bank account records are kept in the storage systems of another existing computer-based system. When the customer uses the ATM to withdrawal money, the following steps may be performed.

The ATM sends a message according to an earlier format to a first transformation module associated with the ATM that a withdrawal is being made. This first transformation module then sends a message to a second transformation module associated with the records of the customer's account alerting it to the requested withdrawal. The message is a record including the request for the withdrawal, the amount requested and other data. The second transformation module then sends an earlier-formatted message to a first device, which tracks the customer's account with the withdrawal request and other information. It will do this with the record format expected by the first device with the information provided in the incoming withdrawal record. Upon receiving the withdrawal record, the first device updates the customer's account balance and sends a record message to the second transformation module informing that the transaction requested is valid. The second transformation module then sends a message to the first transformation module informing it the transaction is valid. The first transformation module then sends a message to the ATM informing the ATM to provide the customer with the requested currency. It also provides the ATM with a record message in the format expected by the ATM including any information required by the ATM to service the withdrawal request.

Given this teaching, it is straightforward to implement other banking procedures through existing computer-based systems and associated transformation modules to provide a unified banking system including disparate existing computer-based systems and associated transformation modules.

The embodiments described herein are merely illustrative of the principles of this invention. Other arrangements and advantages may be devised by one skilled in the art without departing from the spirit or scope of the invention. Accordingly, the invention should be deemed not to be limited to the above detailed description. Various other embodiments and modifications to the embodiments disclosed herein may be made by those skilled in the art without departing from the scope of the following claims.

1. A data transforming system, including:
a plurality of receive interfaces configured to receive data;
a transformation module configured to transform the received data into modified data recognizable by a target system; and
a transmit interface configured to send data to the target system;
wherein the modified data includes a first portion of data from a first receive interface and a second portion of data from a second receive interface, and is configured according to a predetermined format of the target system.

2. The data transforming system of claim 1, wherein the transformation module is configured to preprocess the received data and to provide optimized data to the target system, where the optimized data includes the first portion and second portions of data, and each of the first and second portions of data represents an automated selection of optimal data from corresponding portions of received data from the first and second receive interfaces.

3. The data transforming system of claim 1, wherein the first received data is at least received from a local source.

4. The data transforming system of claim 1, wherein the second received data is at least received from a remote source.

5. The data transforming system of claim 1, wherein the first and the second received data are received from a local source and a remote source, respectively.

6. The data transforming system of claim 1, configured to execute the transformation to generate emulated data recognizable by the target system.

7. The data transforming system of claim 1, wherein the transformation module includes:
at least one receive interface to receive the first and second received data;
a logic module to process the first and second receive data; and
at least one transmit interface to transmit optimized data.

8. The data transforming system of claim 1, further including a third interface configured to send data to a plurality of other data transforming systems.

9. The data transforming system of claim 1 wherein the target system is a combat system.

10. The data transforming system of claim 1 wherein the received data includes at least one track file.

11. The data transforming system of claim 3, further including an override module configured to provide operator-selected data in place of at least one track of the automated selection of optimal data.

12. The data transforming system of claim 3, including logic configured to provide the first received data to the target system through bypass logic of the data transforming system.

13. The data transforming system of claim 1 wherein said data transforming system is a banking system.

14. An integrated plurality of data transforming systems and associated target systems wherein each data transforming system includes:
a plurality of receive interfaces configured to receive data;
a transformation module configured to transform the received data into modified data recognizable by a target system; and
a transmit interface configured to send data to the target system;
wherein the modified data includes a first portion of data from a first receive interface and a second portion of data from a second receive interface, and is configured according to a predetermined format of the target system.

15. The integrated plurality of data transforming systems and associated target systems of claim 14, wherein the transformation module of the data transforming systems is configured to preprocess the first and second received data and to provide optimized data to the target system, where the optimized data includes the first portion and second portions of data, and each of the first and second portions of data represents an automated selection of optimal data from corresponding portions of data from the first and second receive interfaces.

16. An integrated plurality of data transforming systems and associated target systems wherein each data transforming system includes:
a plurality of receive interfaces configured to receive data;
a transformation module configured to transform the received data into modified data recognizable by a target system; and
a transmit interface configured to send data to the target system;
wherein the modified data includes a first portion of data from a first receive interface and a second portion of data from a second receive interface, and is configured according to a predetermined format of the target system; and
wherein additional computer systems are integrated into the integrated plurality of data transforming systems.

17. The integrated plurality of data transforming systems, associated target systems and additional computer systems of claim 16, wherein the transformation module of the data transforming systems is configured to preprocess the first and second received data and to provide optimized data to the target system, where the optimized data includes the first portion and second portions of data, and each of the first and second portions of data represents an automated selection of optimal data from corresponding portions of data from the first and second receive interfaces.

18. A method of generating and transmitting data derived from a first set of received local data and a second set of received remote data including the steps of:
generating automatically optimized data from the first and the second set of received data;
transforming the optimized data into data recognizable to a target system; and
providing the data recognizable to the target system to the target system.

19. The method of claim 18, where the signals include records.

20. The method of claim 18, wherein the received signals include local and remote signals.

21. The method of claim 18, wherein the signals include real-time signals.

22. The method of claim 18, wherein the transformation is performed by providing emulated data recognizable by the target system to the target system.

23. The method of claim 18, wherein the target system is a combat system.

24. The method of claim 18 wherein the first and second sets of received data include track files.

25. The method of claim 18, wherein including user selection of a least one piece of data.

26. The method of claim 18, further including the step of providing the first set of received data to the target system bypassing the transformation module.

27. A system for integrating a plurality of computer-based systems including:
means for receiving data from a plurality of interfaces;
means for transforming the received data into optimized data; and
means for sending the optimized data to a target computer.

28. The system of claim 27, wherein the means for receiving data are interfaces to sensors and networks.

29. The system of claim 27, wherein the means for receiving data are interfaces connected to other computer-based systems.

30. The system of claim 27, wherein the means for sending data are channels to a computer-based target system.

31. A method for integrating naval and maritime combat platforms including:
implementing a common network interface on a plurality of naval combat systems,
the network interface configured to:
a. receive signals and messages including track data from a plurality of sources;
b. optimize the signals and messages;
c. generate a track file that includes the optimized signals and messages; and
d. emulating the signals and messages that a host combat system is configured to receive.
